(19) United States
(12) Patent Application Publication
(10) Pub. No.: US 2018/0141022 A1
(43) Pub. Date: May 24, 2018

(54) PEELING DEVICE OF SHEET MATERIAL

(71) Applicant: LG Chem, Ltd., Seoul (KR)

(72) Inventors: Eun Jeong Kim, Daejeon (KR); Kwang Hyun Yoo, Daejeon (KR); Ye Hoon Im, Daejeon (KR); In Young Kim, Daejeon (KR); Won Jong Kwon, Daejeon (KR)

(73) Assignee: LG Chem, Ltd., Seoul (KR)

(21) Appl. No.: 15/575,113

(22) PCT Filed: Sep. 7, 2016
(86) PCT No.: PCT/KR2016/010027

§ 371 Date: Nov. 17, 2017

(30) Foreign Application Priority Data
Sep. 7, 2015 (KR) 10-2015-0126434

(51) Int. Cl. B01J 19/26; C01B 32/19; B01J 19/08

(52) U.S. Cl. CPC B01J 19/26; B01J 2219/00162; B01J 19/088; C01B 32/19

(57) ABSTRACT

The present invention relates to a peeling device of sheet material for peeling off graphite, and the peeling device of sheet material according to the present invention is characterized in that a specific microchannel is used to apply a shear force required to peel off graphite, and simultaneously, various sizes of shear forces can be applied according to the sections in the microchannel, thus increasing graphene preparation efficiency.

### CROSS-REFERENCE TO RELATED APPLICATION(S)

This application claims the benefit of Korean Patent Application No. 10-2015-0126434 filed on Sep. 7, 2015 with the Korean Intellectual Property Office, the disclosures of which are herein incorporated by reference in their entirety.

The present invention relates to a peeling device of sheet material that is effective for peeling off graphite and can prepare large area graphene, and a method for preparing graphene using the device.

### BACKGROUND ART

Graphene is a half-metallic material forming an arrangement wherein carbon atoms are connected in a two-dimensional hexagonal shape by sp2 bonds, and having a thickness corresponding to the carbon atom layer. Recently, it has been reported that as the result of assessing the properties of a graphene sheet having one layer of carbon atoms, electron mobility is about 50,000 cm²/Vs or more, thus exhibiting very excellent electric conductivity.

Further, graphene has characteristics of structural and chemical stability and excellent thermal conductivity. In addition, since it consists only of carbon, relatively light atom, it is easy to process one dimensional or two dimensional nanopattern. Due to such electrical, structural, chemical and economical properties, graphene is predicted to replace silicon-based semiconductor technology and transparent electrodes from now on, and particularly, it is expected to be applied in the field of flexible electronic devices due to the excellent mechanical properties.

Due to such many advantages and excellent properties of graphene, various methods capable of more effectively mass-producing graphene from carbonaceous material have been suggested or studied. Particularly, studies on the methods capable of easily preparing graphene sheets or flakes having thinner thickness and large area have been variously progressed, so that the excellent properties of graphene may be manifested more dramatically.

As the existing method of preparing graphene, methods of obtaining graphene or oxides thereof by peeling off by physical methods such as using a tape, or chemical methods such as oxidation of graphite, or by peeling off an intercalation compound in which acid, base, metal, etc. are inserted between the carbon layers of graphite, are known. Recently, a method of preparing graphene by peeling off carbon layers included in graphite by milling with a ball mill or ultrasonic irradiation, while dispersing graphite in a liquid phase, is being commonly used. However, these methods have disadvantages in that graphene defects are generated, processes are complicated, and graphene yield is low.

Meanwhile, a peeling device of sheet material is a device of applying a high pressure to a microchannel having a micrometer scale diameter, thus applying a strong shear force to the material passing it through, and if graphite is peeled off using the sheet peeling device, graphene yield can be increased.

However, a peeling device of sheet material is commonly designed and prepared with the purpose of crushing and dispersing of particles, and a difference in shear force according to the sections in the microchannel is not large. Since the interlayer bonding force of graphene is different according to the impurities included in graphite or crystallinity difference, etc., in case passing through the above described microchannel only once, non-peeled off layers may remain and should be further passed through the microchannel, and thus, peeling time may increase and productivity may decrease.

Accordingly, as the result of studies on sheet peeling devices that are effective for peeling off graphite and can prepare large area graphene, the present inventors confirmed that if a microchannel of a specific shape as described below is used to apply various shear forces to graphite passing it through, the above problems can be solved, and completed the present invention.

### DETAILED DESCRIPTION OF THE INVENTION

### Technical Problem

It is an object of the present invention to provide a peeling device of sheet material that is effective for peeling off graphite and can prepare large area graphene.

It is another object of the present invention to provide a method for preparing graphene using the above peeling device of sheet material.

### Technical Solution

In order to solve the problems, the present invention provides a peeling device of sheet material comprising:

an inlet into which sheet material is supplied;

a high pressure pump that is positioned at the front end of the inlet, and generates a pressure for pressurizing the sheet material;

a microchannel positioned at the back end of the inlet, through which the sheet material passes by the pressure generated by the high pressure pump, whereby the sheet material is peeled off; and

an outlet positioned at the back end of the microchannel,

wherein the cross sectional area of the microchannel decreases from the front end of the inlet side to the back end of the outlet side.

Further, the present invention provides a method for preparing graphene using the above peeling device of sheet material, said method comprising the steps of: 1) supplying a solution comprising graphite to the inlet; 2) putting pressure on the inlet with a high pressure pump to pass the solution comprising graphite through the microchannel; and 3) recovering a graphene dispersion from the outlet.

### Advantageous Effects

The peeling device of sheet material according to the present invention is characterized in that graphene preparation efficiency may be increased without grinding graphene itself, by using a specific microchannel.

### BRIEF DESCRIPTION OF DRAWINGS

FIG. 1 is a schematic diagram of the peeling device of sheet material according to the present invention.

FIG. 2 shows the flow rates in the microchannels of the sheet peeling device according to the present invention and the sheet peeling device of Comparative Example.

FIG. 3 shows the shear forces in the microchannels of the sheet peeling device according to the present invention and the sheet peeling device of Comparative Example.

### DETAILED DESCRIPTION OF THE EMBODIMENTS

Hereinafter, the present invention will be explained in detail.

A peeling device of sheet material means a device that applies high pressure to a microchannel having a micrometer scale diameter, so as to apply a strong shear force to the material passing it through. By the shear force, the material passing through the microchannel is ground and dispersed, and thus, it is being used for preparing highly dispersed material. Thus, the peeling device of sheet material is being used for the preparation of products requiring high dispersion, for example, in various fields such as electrical/electronic material, bioengineering, pharmaceutical, food, fiber, painting, cosmetic industries, etc.

Meanwhile, since the peeling device of sheet material is designed and prepared for peeling, crushing and grinding of material through a strong shear force, in general, devices with a constant cross sectional area of a microchannel are used so that shear force in the microchannel may be constant. However, the microchannel having a constant cross sectional area may be a disadvantage according to the purpose of use of a sheet peeling device.

Particularly, the present invention relates to the preparation of graphene from graphite using a peeling device of sheet material, and aims to induce delamination of graphite. Since the interlayer bonding force of graphene is different according to the impurities included in graphite or crystallinity difference, etc., in case a constant shear force is applied, non-peeled off layers may remain. Thus, the number of times passing through the microchannel should be increased so as to additionally peel off graphite, which increases peeling time and decreases productivity.

Therefore, the present invention provides a peeling device of sheet material wherein various sizes of shear forces can be applied according to the sections in the microchannel, within a range where a shear force required to peel off graphite is applied.

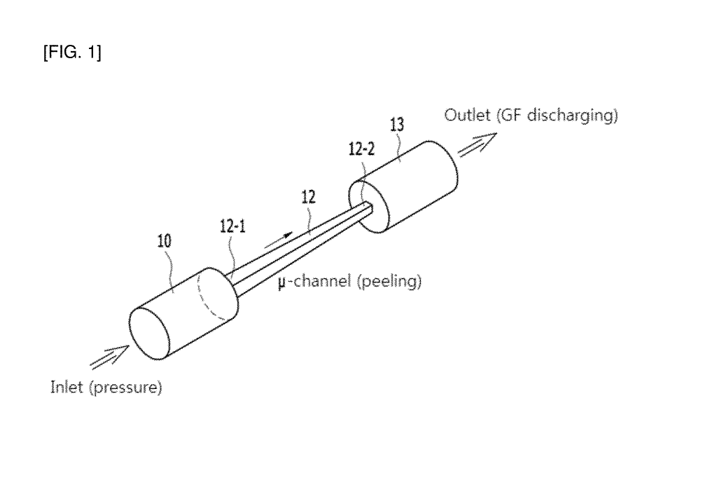

First, FIG. 1 is a schematic diagram of the peeling device of sheet material according to the present invention. The peeling device of sheet material (1) according to the present invention comprises an inlet (10) into which sheet material is supplied; a high pressure pump (11, not shown) that is positioned at the front end of the inlet (10), and generates a pressure for pressurizing the sheet material; a microchannel (12) positioned at the back end of the inlet (10), through which the sheet material passes by the pressure generated by the high pressure pump, whereby the sheet material is peeled off; and an outlet (13) positioned at the back end of the microchannel (12).

Thus, pressure is applied to the inlet (10) by the high pressure pump (11), and sheet material supplied in the inlet (10) passes through the microchannel (12). Since the cross sectional area of the microchannel (12) is small, if a pressure higher than the pressure applied to the inlet (10) is applied to the microchannel (12), and the sheet material receives a strong shear force and peeled off. The sheet material passing through the microchannel (12) is discharged to the outlet (13).

Particularly, in the present invention, the sheet material may be graphite, and peeling may occur by the strong shear force in the microchannel (12) to prepare graphene. Here, the microchannel (12) is characterized in that the cross sectional area decreases from the front end (12-1) of the inlet side to the back end (12-2) of the outlet side, so that various sizes of shear forces may be applied according to the sections in the microchannel (12). That is, the microchannel (12) is tapered from the front end (12-1) of the inlet side to the back end (12-2) of the outlet side. Further, the cross section of the microchannel (12) may be circular or polygonal (square, trapezoid, etc.), and is not specifically limited.

Since the interlayer bonding force of graphite is not fixed to a certain value but varies according to graphite, it is favorable for peeling of graphite to apply various sizes of shear forces rather than applying a constant shear force. Further, if graphite suddenly receives high shear force in a microchannel, there is a concern that graphite may be ground before peeled. Thus, if a small shear force is applied when graphite is inflowed into a microchannel and gradually high shear force is applied while passing through the microchannel, peeling efficiency may be increased while inhibiting grinding of graphite. For this, the present invention is characterized in that the microchannel (12) is tapered from the front end (12-1) at the inlet side to the back end (12-2) at the outlet side.

Thus, the microchannel according to the present invention has the effect of gradually increasing a flow rate and a shear rate in the flow direction, due to the tapered shape, thereby gradually increasing a shear force in the flow direction instead of a fixed shear force.

Preferably, the ratio of the cross sectional area of the microchannel at the front end of the inlet side and the cross sectional area of the microchannel at the back end of the outlet side is 1:0.1-0.9. Further, preferably, the cross sectional area of the microchannel at the front end of the inlet side is 2.5×10³ um² to 1.5×10⁸ um². Further, preferably, the taper angle of the microchannel is 1° to 10°.

Further, the peeling device of sheet material according to the present invention may be equipped with a supply line for supplying sheet material to the inlet (10). Through the supply line, the input of sheet material, etc. can be controlled.

Further, the present invention also provides a method for preparing graphene using the above sheet peeling device, said method comprising the steps of:

1) supplying a solution comprising graphite to the inlet (10);

2) putting pressure on the inlet (10) with a high pressure pump (11) to pass the solution comprising graphite through the microchannel (12); and

3) recovering a graphene dispersion from the outlet (13).

The pressure of the step 2 is preferably 500 to 3000 bar. Further, after recovering a graphene dispersion from the outlet (13), it may be reintroduced into the inlet (10). The reintroduction process may be conducted 2 to 15 times repeatedly. The reintroduction process may be conducted using the sheet peeling device used, or using plural sheet peeling devices. Further, the reintroduction process may be conducted dividedly according to the process, or may be continuously conducted.

Meanwhile, the method for preparing graphene may further comprise the steps of recovering graphene from the recovered graphene dispersion and drying it. The recovery step may be progressed by centrifugation, vacuum filtration or pressure filtration. Further, the drying step may be conducted by vacuum drying or general drying at a temperature of about 30 to 200° C.

Further, the size of graphene prepared according to the present invention is large and uniform, and thus, favorable for the realization of the unique properties of graphene. The prepared graphene may be redispersed in various solvents and utilized as various uses such as a conductive paste composition, a conductive ink composition, a composition for forming a heat radiating substrate, an electro-conductive complex, a thermally conductive complex, a complex for shielding EMI, or conductor or slurry for batteries, etc.

Hereinafter, preferable examples are presented for better understanding of the present invention. However, these examples are presented only as the illustrations of the present invention, and the present invention is not limited thereby.

### EXAMPLES AND COMPARATIVE EXAMPLES

In order to evaluate the properties of the peeling device of sheet material according to the present invention, a microchannel as shown in FIG. 1 was used. A device comprising an inlet (10), a microchannel (12) and an outlet (13) as shown in FIG. 1 was used. An inlet (10) and an outlet (13) respectively in cylindrical shapes (diameter 1500 um and height 2500 um) were used, and a microchannel (12) wherein the width and the height of the cross section (square cross section) of the microchannel at the front end (12-1) of the inlet side are respectively 400 um, and the width and the height of the cross section (square cross section) of the microchannel at the back end (12-2) of the outlet side are respectively 200 um, and the total length is 3,000 um, was used.

As a Comparative Example, the same peeling device of sheet material as described above was used, except that a microchannel wherein the width and the height of the cross section of the microchannel are respectively 400 um and are identical over the whole sections, and the total length is 3,000 um was used.

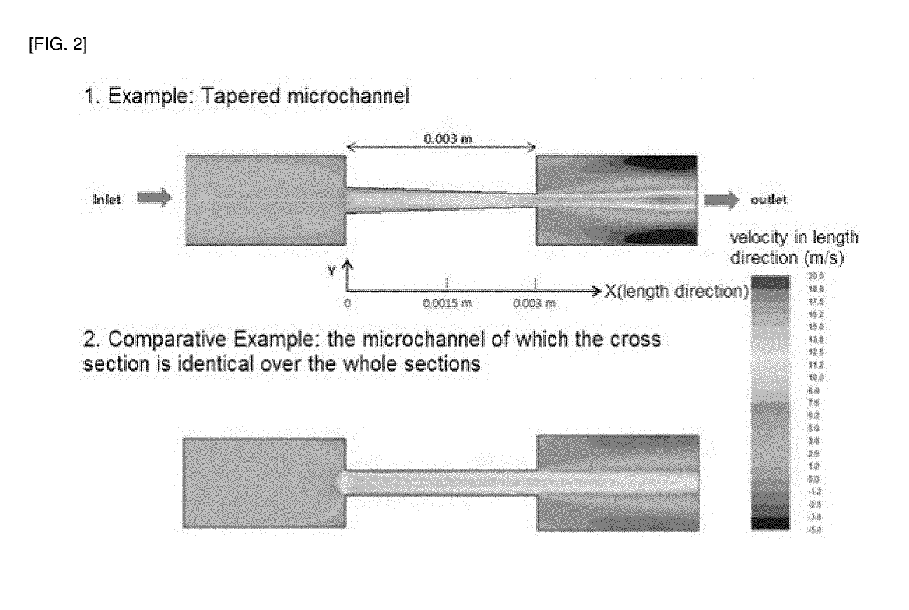

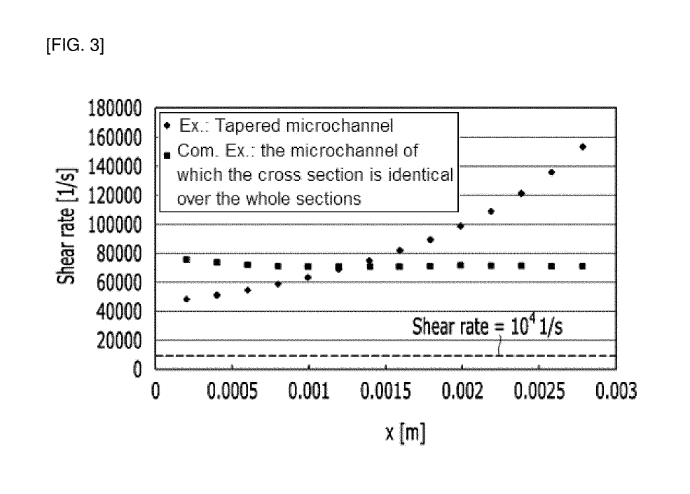

Using the peeling devices of sheet material, CFD (Computational Fluid Dynamics) analysis was conducted, and the results are respectively shown in FIG. 2 and FIG. 3. As shown in FIG. 2 and FIG. 3, it was confirmed that in the peeling device of sheet material according to the present invention, the flow rate and the shear force gradually increase toward downstream in the flow direction. Thus, it can effectively broaden the range of shear force compared to the existing microchannel as Comparative Example, and can increase the peeling efficiency for graphite having different interlayer bonding force.

### EXPLANATION OF SIGN

1: peeling device of sheet material

10: inlet

11: high pressure pump

12: microchannel

12-1: front end of microchannel

12-2: back end of microchannel

13: outlet

1. A peeling device of sheet material comprising
an inlet into which sheet material is supplied;
a high pressure pump that is positioned at the front end of the inlet, and generates a pressure for pressurizing the sheet material;
a microchannel positioned at the back end of the inlet, through which the sheet material passes by the pressure generated by the high pressure pump, whereby the sheet material is peeled off; and
an outlet positioned at the back end of the microchannel, wherein the cross sectional area of the microchannel decreases from the front end of the inlet side to the back end of the outlet side.

2. The peeling device of sheet material according to claim 1, wherein the ratio of the cross sectional area of the microchannel at the front end of the inlet side and the cross sectional area of the microchannel at the back end of the outlet side is 1:0.1-0.9.

3. The peeling device of sheet material according to claim 1, wherein the cross sectional area of the microchannel at the front end of the inlet side is 2.5×10³ um² to 1.5×10⁸ um.

4. The peeling device of sheet material according to claim 1, wherein the taper angle of the microchannel is 1° to 10°.

5. The peeling device of sheet material according to claim 1, wherein a supply line for supplying the sheet material to the inlet is equipped.

6. The peeling device of sheet material according to claim 1, wherein the sheet material is graphite.

7. A method for preparing graphene using the peeling device of sheet material according to claim 1, said method comprising the steps of:
1) supplying a solution comprising graphite to the inlet;
2) putting pressure on the inlet with a high pressure pump to pass the solution comprising graphite through the microchannel; and
3) recovering a graphene dispersion from the outlet.

8. The method for preparing graphene according to claim 7, wherein the pressure of the step 2 is 500 to 3000 bar.
